(19) United States
(12) Patent Application Publication
(10) Pub. No.: US 2010/0141417 A1
(43) Pub. Date: Jun. 10, 2010

(54) TIRE SENSOR MODULE

(76) Inventor: Thomas- Achim Boes, Wannweil (DE)

Correspondence Address: KENYON & KENYON LLP, ONE BROADWAY, NEW YORK, NY, 10004, US

(21) Appl. No.: 12/449,995

(22) PCT Filed: Jan. 9, 2008
(86) PCT No.: PCT/EP2008/050173

§ 371 Date: Feb. 19, 2010

(30) Foreign Application Priority Data
Mar. 5, 2007 (DE) 10 2007 010 505.5

(51) Int. Cl. B60C 23/00; G01M 17/02

(52) U.S. Cl. 340/447; 73/146

(57) ABSTRACT

A tire sensor module for use in a vehicle tire including at least one sensor device for measuring at least one measured variable and for outputting at least one measuring signal, a control device, e.g., an analyzer ASIC for receiving the measuring signal and for outputting at least one transmitted signal to a wireless interface for emitting the transmitted signal to a receiver in or on the vehicle, and an energy accumulator, in particular a battery, for supplying power to at least the control device. A switching device is provided between the energy accumulator and the control device which interrupts or closes the power supply of the control device by the energy accumulator as a function of a control signal, and an electromechanical energy transducer which, under the effect of a deformation, a motion and/or a pressure change, outputs the control signal, in particular a piezoelectric voltage, to the switching device for closing the power supply.

### FIELD OF THE INVENTION

The present invention relates to a tire sensor module for use in a vehicle tire for ascertaining state variables of a vehicle tire.

### BACKGROUND INFORMATION

Tire sensors are used for measuring different state variables, in particular the pressure and the temperature, sometimes also the acceleration of the vehicle tire. Since they cannot be connected to external voltage sources, different systems for the power supply and for reducing the current consumption are known.

On the one hand, the power supply may take place by a built-in battery which, however, has a limited service life and which thus limits the service life of the entire tire sensor. For reducing the current consumption, a roll detection device is sometimes installed in the tire electronics in which a current consumption is reduced by shutting off parts of the analyzer ASIC (application-specific integrated circuit) to extend the service life of the battery. Moreover, when the wheel, e.g., the spare wheel, does not move, a sleep mode of the electronics is activated in some systems, preventing unnecessary transmission in the rest mode.

For implementing this function, the mechanical switch, an acceleration sensor, or a piezoelectric component may be used using which the transition from the sleep mode into the operating mode may be detected. This component is regularly detected and analyzed by a part of the analyzer ASIC which is continuously supplied with current. The analyzer ASIC must thus be supplied continuously from a battery as the voltage supply for which purpose a constant bias current flows in the ASIC even when no query takes place. This bias current and the additional current for querying the roll detection device result in too high current consumptions and thus to a reduction in the service life of the system.

Moreover, tire sensor systems are known in which a piezoelectric component is used as an electromechanical energy converter for the voltage supply so that the use of a battery as a service life-limiting component is not necessary. Such sensor systems thus generate power only when the wheel is in motion; accordingly, a large piezoelectric component is necessary to generate the power required for the analyzer ASIC, the operation of the sensor, as well as of the antenna.

Such a large piezoelectric component is expensive to manufacture and, furthermore, requires a larger installation space in the vehicle tire; an adequate power generation may ultimately only be achieved in the area of the tire tread in which the mechanical deformations are large enough.

### SUMMARY OF THE INVENTION

The exemplary embodiments and/or exemplary methods of the present invention includes supplying power to the control device and the analyzer ASIC basically by a battery or by a consumable energy accumulator, but to close and open the power supply using an additional electromechanical energy transducer. According to the exemplary embodiments and/or exemplary methods of the present invention, in addition to the control device and the analyzer ASIC, the sensor device and possibly further components such as an HF chip or a crystal oscillator, and an antenna, the battery, and the electromechanical energy transducer are connected to a switching device which is advantageously designed as a switch ASIC. The switch ASIC interrupts and closes the power supply of the analyzer ASIC by the battery as a function of the output signal of the electromechanical energy transducer or the piezoelectric component.

When the wheel is in motion, power is generated in the electromechanical energy transducer which is output to the switch ASIC as a control signal or a switching signal, thereby closing the power supply between the battery and the analyzer ASIC.

When the tire is at a standstill, no power is generated in the electromechanical energy transducer so that the analyzer ASIC is completely disconnected from the battery.

According to the exemplary embodiments and/or exemplary methods of the present invention, a complete decoupling or disconnect of the control device and the analyzer ASIC and the other electronic components from the battery is thus possible, thereby saving energy when the tire is at a standstill.

According to the exemplary embodiments and/or exemplary methods of the present invention, a complete decoupling by the switch ASIC may be achieved which results in a significantly better reduction of the power consumption than is the case in conventional sleep mode settings having a residual bias current or leakage current. The service life of the battery and thus also the service life of the system may be substantially extended due to the power savings in comparison with conventional, battery-fed sensor modules. An energetically self-sustaining, long-lasting sensor module is thus created. The switch ASIC is closed by the (piezoelectric) voltage of the electromechanical energy transducer and is opened in the idle state and the battery is thus also not strained.

According to the exemplary embodiments and/or exemplary methods of the present invention, when the wheel is in motion there is still a strong enough battery available having a high capacity and a constant supply voltage for operating the analyzer ASIC and the additional electronic components, whereby substantial advantages are achieved compared with conventional systems supplied by electromechanical energy conversion, in particular with regard to reliability, accuracy of measurement, and signal strength.

Compared with such systems having electromechanical energy converters, a smaller electromechanical energy converter may be configured according to the exemplary embodiments and/or exemplary methods of the present invention since only the switch ASIC (the switching device) must be controlled. Additional cost advantages are achieved hereby and a use outside of the tire tread, e.g., in the valve area of the tire, is also possible since no more relevant operating currents are necessary.

Compared with conventional battery-operated systems, a smaller battery or a battery with a smaller capacity may be used, thereby reducing the costs and the overall size.

### BRIEF DESCRIPTION OF THE DRAWINGS

FIG. 1 shows a block diagram.

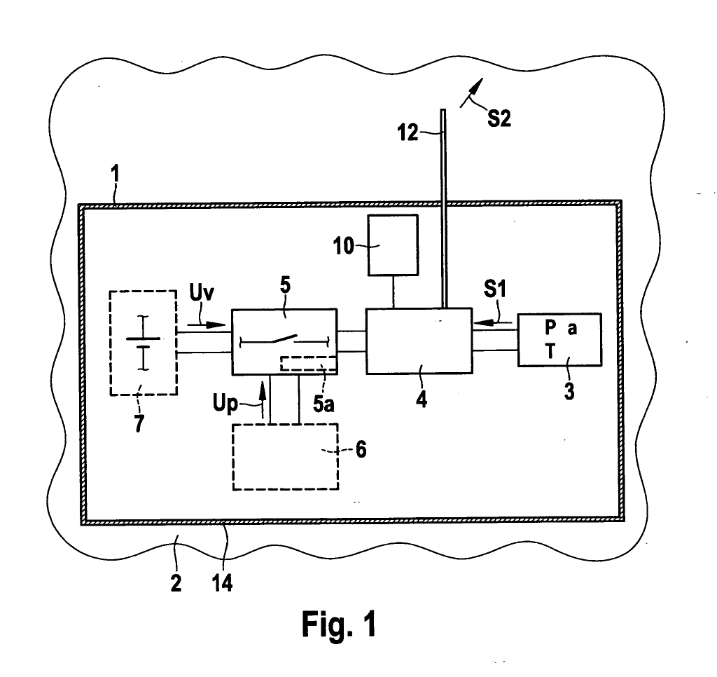

FIG. 2 shows a flow chart of a method according to the present invention.

### DETAILED DESCRIPTION

A tire sensor module 1 is situated in a vehicle tire 2, e.g., in the valve area or also in the tire tread of vehicle tire 2.

Tire sensor module 1 has a sensor device 3, which is advantageously designed as a pressure/temperature sensor for measuring pressure P as well as temperature T, an analyzer ASIC 4 as an analyzer and control device, a switch ASIC 5 as a switching device according to the present invention, a piezoelectric component 6 as well as a battery 7 and a crystal oscillator 10. Pressure/temperature sensor 3 obtains measured values of pressure P and temperature T in a known manner and outputs corresponding measuring signals S1 to analyzer ASIC 4, i.e., it is read out by analyzer ASIC 4. In addition to pressure P and temperature T, accelerations a, i.e., also vibrations, may also be measured.

Analyzer ASIC 4 is connected to crystal oscillator 10 for generating the HF transmission frequency; analyzer ASIC 4 thus analyzes measuring signals of P and T and outputs HF signals S2 to a receiver in the vehicle via a connected antenna 12. Antenna 12 may be formed on the inside and/or on the outside of housing 14 of tire sensor module 1, for example.

According to the exemplary embodiments and/or exemplary methods of the present invention, a battery 7 is provided as the power supply of analyzer ASIC 4 and furthermore also for sensor device 3, and for crystal oscillator 10 and for antenna 12. Battery 7 may be in particular a non-rechargeable galvanic element and outputs a direct voltage Uv as the supply voltage. Switch ASIC 5 is connected between analyzer ASIC 4 and battery 7 and receives its power from piezoelectric component 6. Switch ASIC 5 has the function of a switch which disconnects battery voltage Uv from analyzer ASIC 4.

Piezoelectric component 6 may be formed in a manner known per se by a multi-layer system having one or multiple layers made of piezoelectric ceramics, the multi-layer stack taking up different bending positions during mechanical deformation and/or motion, thereby outputting a piezoelectric voltage Up which changes over time. In the event of a rolling motion of vehicle tire 1, piezoelectric component 6 generates piezoelectric voltage Up due to the deformation of tire tread 2 or due to the motion, and according to the present invention the piezoelectric voltage as a switching signal adjusts switch ASIC 5. Piezoelectric component 6 is thus used for the power supply as well as the signal source for switch ASIC 5. Battery 7 is thus not strained when the switching function of switch ASIC 5 is open since it does not supply power to analyzer ASIC 4 nor to switch ASIC 5.

When the vehicle wheel is in motion, power is generated in piezoelectric component 6 due to the deformation of tire tread 2, or also, for example, due to the inertia of the piezoelectric component or an applied seismic mass, and the generated piezoelectric voltage Up is output which closes switch ASIC 5. Analyzer ASIC 4 is thus completely supplied by battery voltage Uv. When the wheel is at a standstill, no power is generated in piezoelectric component 6 so that switch ASIC 5 opens and disconnects analyzer ASIC 4 from battery 7.

According to a specific embodiment of the present invention, a delay in the switching function may be provided in switch ASIC 5 so that at a temporary standstill of the vehicle wheel, e.g., in stop-and-go traffic or at a traffic sign or at a traffic light, battery 7 still supplies analyzer ASIC 4 for a short period of time, thus making a continuous measuring operation and data transmission via the power supply of battery 7 possible. For this purpose, switch ASIC 5 may have a temporary energy accumulator 5a, e.g., as a capacitor having suitably large capacitor surfaces in order to hereby delay the opening switching function. Basically, an intelligent switch ASIC 5 may also be used. However, it has been found according to the exemplary embodiments and/or exemplary methods of the present invention that such a delay is basically unnecessary since during the standstill a relevant change in the measuring data is not to be expected or the changes may be detected in time during the subsequent wheel rotation.

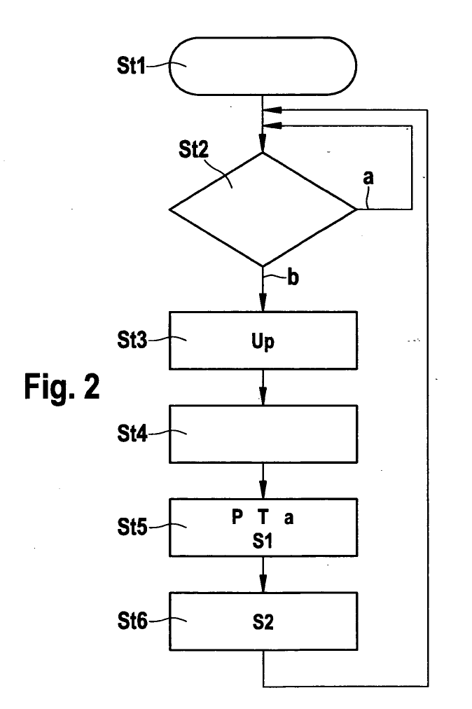

FIG. 2 shows a flow chart depicting a possible specific embodiment of the method according to the present invention. The method is started in step St1; this may take place already as the vehicle tire is mounted, since tire sensor module 1 according to the present invention is self-sustained and is not activated from the vehicle. Subsequently, the operation takes place in the shown loop in which the method is reset in step St2 according to branch a when piezoelectric component 6 detects no motion of vehicle tire 2; thus no active measuring and transmission operation takes place. If, according to branch b, the piezoelectric component detects a motion of the vehicle tire, in step St3 it outputs piezoelectric voltage Up or a correspondingly rectified switching voltage to the switch ASIC whereupon switch ASIC 5 is closed in step St4, thereby supplying current to analyzer ASIC 4, crystal oscillator 10, sensor device 3, and antenna 12. Thus, the measuring and transmission operation starts in which, according to step St5, sensor device 3 measures state variables P, T and possibly also a, and outputs measuring signals S1 to analyzer ASIC 4 which, according to step St6, generates HF signals with the aid of crystal oscillator 10 and outputs them as transmitted signals S2 via antenna 12.

This transmission and measuring operation takes place according to the shown loop as long as piezoelectric component 6 keeps switch ASIC 5 closed in step St2.

1-14. (canceled)

15. A tire sensor module for use in a vehicle tire, comprising:
at least one sensor device to measure at least one measured variable and output at least one measuring signal;
a control device to receive the at least one measuring signal and output at least one transmitted signal to a wireless interface to emit the transmitted signal to a receiver of the vehicle;
an energy accumulator for the power supply of at least the control device;
a switching device between the energy accumulator and the control device, wherein the switching device interrupts or closes the power supply of the control device by the energy accumulator as a function of a control signal; and
an electromechanical energy transducer, under the effect of at least one of a deformation, a motion and a pressure change, to output the control signal to the switching device for closing the power supply.

16. The tire sensor module of claim 15, wherein the energy accumulator is a battery, which is a non-rechargeable galvanic cell.

17. The tire sensor module of claim 15, wherein the electromechanical energy transducer includes a piezoelectric component, which, under the effect of the at least one of the deformation, the motion, and the pressure change, outputs a piezoelectric voltage or a signal generated from the piezoelectric voltage as the control signal to the switching device.

18. The tire sensor module of claim 17, wherein the electromechanical energy transducer or the switching device includes a rectifier circuit to rectify the generated piezoelectric voltage.

19. The tire sensor module of claim 15, wherein the switching device includes an ASIC switch having at least one MOSFET used as a switch.

20. The tire sensor module of claim 15, wherein the control device analyzes the received measuring signal, forms an HF signal from it and emits the HF signal as the transmitted signal via the wireless interface.

21. The tire sensor module of claim 20, wherein a crystal oscillator for generating the HF signal is connected to the control device,

22. The tire sensor module of claim 15, wherein an antenna is formed in or on the housing of the tire sensor module as the wireless interface.

23. The tire sensor module of claim 15, wherein the control device is an analyzer ASIC.

24. The tire sensor module of claim 15, wherein the tire sensor module is at least one of affixed to a tire valve and placed in a tire tread of the vehicle tire.

25. The tire sensor module of claim 15, wherein the tire sensor module is energetically self-sustaining.

26. The tire sensor module of claim 15, wherein, after the absence of the control signal, the switching device still maintains the power supply for a predefined period of time.

27. The tire sensor module of claim 26, further comprising:
a temporary energy accumulator to temporarily store the control signal output by the electromechanical energy transducer.

28. A method for ascertaining state variables of a vehicle tire, the method comprising:
supplying, during a drive, a control device of a tire sensor module with power;
receiving at least a measuring signal which reflects a state variable of the vehicle tire;
forming a wireless transmitted signal from the measuring signal;
outputting the wireless transmitted signal via a wireless interface;
switching a power supply of the control device by a switching device;
closing the power supply during the drive under the effect of at least one of an external deformation, a motion and an external pressure on the tire sensor module; and
interrupting the power supply at a standstill of the tire.
